(19) United States
(12) Patent Application Publication
(10) Pub. No.: US 2005/0075897 A1
(43) Pub. Date: Apr. 7, 2005

(54) Multi-media two part business method for production of yearbooks and books of pleasant memories

(76) Inventor: Michael A. Mazzulo, Unionville, PA (US)

Correspondence Address: Don A. Erlandson;Attorney at Law, 11 Guenever Drive, New Castle, DE, 19720-2922, US

(21) Appl. No.: 10/703,723

(22) Filed: Nov. 5, 2003

Related U.S. Application Data
(60) Provisional application No. 60/424,390, filed on Nov. 8, 2002.

(51) Int. Cl. G06F 17/60

(52) U.S. Cl. 705/1

(57) ABSTRACT

A two part business method for production of a “Yearbook” is described, directed to small and medium sized colleges and high schools; also to fraternal organizations, citizen action groups, non-profits, and social clubs of all sorts. Any entity which sponsors a “book of memories” and is seeking ways to keep costs in check would find the method interesting and useful. The method contemplates keeping the production in house and under the schools' or clubs' control at all times, by supplementing or eliminating the standard hard bound book of photographs; and adding CD/DVD'S plus a hardcover ‘picture book’ with removable pages and a lace binding; not rings. The discs would be ‘burned’ by the school and would include music; with descriptions and/or visuals of all events and people of interest to the student body or the organization's members' as a whole. For a school, the picture book would have pages with only the cover displaying the school, and class year. The pages would be readily removable by the students in order to mount digital photographs of friends and faculty, with room ample for signatures and dedications. The school could rent digital cameras to any who did not own one. The same procedures would work to the advantage of a club or fraternal group. For the latter, the fraternal organizations might want the cover to depict their favorite “cause”. A school or college might decorate the front cover of the picture book with the slogan and insignia of the institution and a picture of the “landmark” building. The loose leaf pages of the picture book will allow any school to publish news of spring events, class pictures, and graduation without worry about the late winter deadlines required to make-up the usual hard bound yearbook.

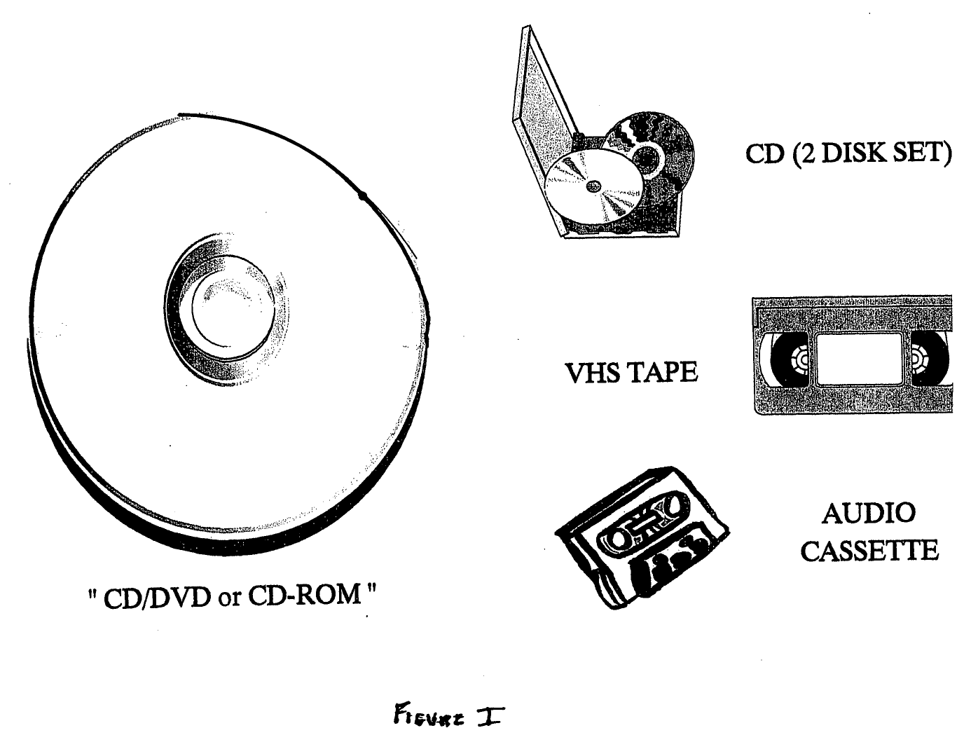

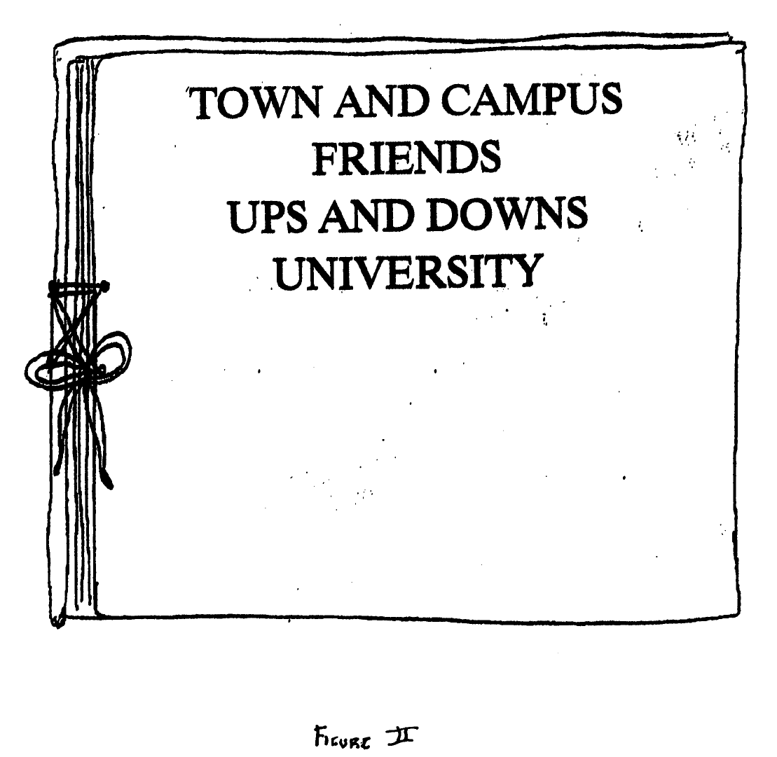

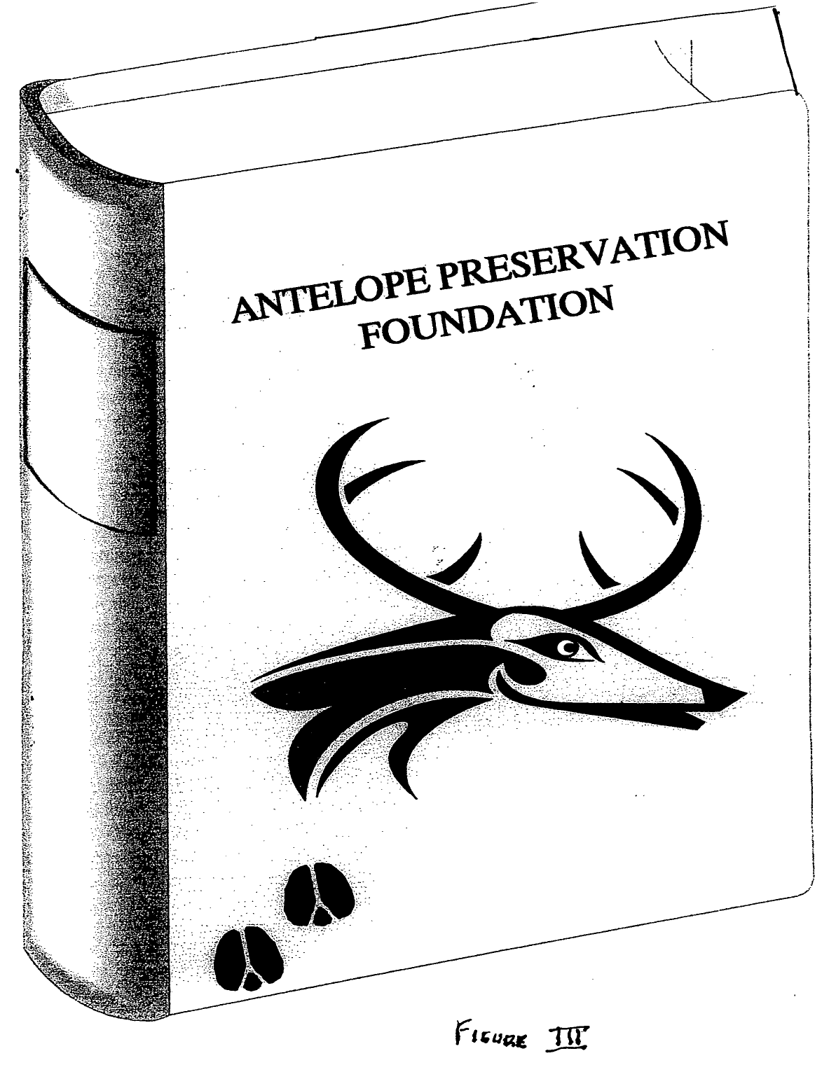

### CROSS REFERENCE TO RELATED APPLICATIONS

This application claims the benefit of U.S. Provisional Application of inventor Michael A. Mazulo entitled “A Multi-Media Two Part Business Method for Production of Yearbooks and Books of Pleasant Memories” filed in the US Patents Office Nov. 8, 2002.

### FEDERALLY SPONSORED RESEARCH OR DEVELOPMENT IS NOT APPLICABLE TO THIS INVENTION

### BACKGROUND OF THE INVENTION

The tradition of the high school and college yearbook has been with the educational system for many many years. As the books got bigger and fuller they also got very expensive. Economic factors and the need for more sophisticated production equipment forced most schools to outsource their yearbooks. Outsourcing lead to publishing deadlines such as requiring all material to be ready for the editor by early February. Spring events and graduation didn't make the book until fall. The present years graduates were gone by then, and only a few schools generated a supplement for them.

A favorite pastime of freshmen sophomores and juniors has always been the collecting of autographs and dedications next to the pictures of classmates in their yearbooks. As class sizes grew it became almost impossible to find room for writings in the small space beside any given photo.

The present invention solves the space problem by providing the student with a blank letter size loose-leaf picture book, employing a lace binding, to allow the pages to instantly removed, mounted with digital photos and replaced. The hardcover picture book can be carried to class and the owner will be able to obtain all of the writings desired.

The picture book will also be a great convenience to the school for class pictures which miss the deadline for the hardback book.

The CD-Roms and DVD's of the instant invention provide another convenience to the school. Since the discs depict both sight and sound they can serve as a supplement to the traditional bound yearbook or as a substitute for it.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in a typical yearbook production system. Those of ordinary skill in the art will recognize that other elements are desirable and/or required in order to implement the present invention. However, because such elements are well known in the art, and because they do not facilitate a better understanding of the present invention, a discussion of such elements is not provided herein.

The invention comprises a Multi-Media Two Part Business method and apparatus, for production of a school or college yearbook. One part uses CD's or DVD's or CD-Roms, and the other consists of a picture book with blank easily removable pages. Recording is done on the schools electronic equipment and reproduction is done on computers and burners.

The audio/visual portion of the invention uses high capacity discs or tapes; the exact capacity would be determined by the needs of the producer. As an example, only, there are now available discs which have 4.7 gigabytes of space, which equals 4,700 megabytes. An average photograph would take up only 1 megabyte. Each disc of this type will hold 80 minutes of visuals. Some schools or clubs may prefer to use only CD's, others may prefer to include visuals with sound, on a DVD or CD-Rom. Tapes could be substituted. Discs are the preferred embodiment.

The DVD may prove to be the most popular because it can be played on television while the CD-Rom is only for computers. Multi-Media discs will find their place as a supplement to regular yearbooks in large schools, and as a substitute in smaller ones.

The Multi-Media presented by the CD-Rom or CD/DVD, or tapes, could comprise any mix which fit the sponsors agenda such as clips from plays, visuals of sports contests, award ceremonies, glee clubs, school or fraternal chorus, assemblies, marching bands, recitals, choral; also slide presentations, faculty or officer interviews, excerpts of historical happenings, still pictures of campus architecture and gardens, and narration of notable events of the immediate past years of the class or club members.

In short the Multi-Media could be used in all of its facets to depict anything of importance to the mind and emotions; to show it in sound, sight, and music; and in color or black and white as appropriate.

The other half of the Two Part Business Method, the picture book, would uphold the tradition of the ‘Yearbook” as a separate hardcover volume. In the preferred embodiment, the binding would be the old-fashioned lace type, to assure that the pages are easy to take out. The book dimensions would average letter size, but could be larger or smaller depending upon the student body desires as made known to the school.

The student or club member would be encouraged to mount digital photographs of favorite friends; and especially their “hang-out group” ample room for signing autographs and writing witty comments. Other types of bindings than the forgoing would be in the scope of the method as long as the pages were accessible for easy removal or addition.

The removable pages would be especially useful to schools who had to forgo the classic yearbook, as a medium for publication of class pictures. This would avoid the frantic early spring deadlines that class photos always have to meet; and the loose-leaf pages would allow any institution to publish news of late breaking events even up to including graduation. The miracle of digital photography would work to the schools great advantage. It would definitely be in the schools interest to rent digital cameras to students who did not have one and who had bought the book.

This invention relates primarily to the field of control systems and methods, and, more particularly to the field of control wherein tracking and placement are desired, and, yet more particularly, to the field of physical and electronic management of audio visual materials, including tracking and reconciliation, using an external apparatus and/or network to produce a Multi-Media disc; which disc presents sights and sounds representative of the plans and desires of the producer. The system and method includes a loosely bound volume of blank pages as an integral second part; which volume acts as a backup to the disc, and is subject to the same tracking, reconciliation and control, both physical and electronic, as the former production, but which ultimately would receive input and placement of materials by the user.

1) A Two Part Business Method and Control System involving tracking, reconciliation, and placement of audiovisual materials; using an external apparatus and/or network to produce a multi-media disc or tape which presents visuals, sound and music; further comprising a loosely bound volume of blank removable pages, as an integral second part subject to the same tracking, reconciliation and control as the first part; but which volume is ultimately externally physically acted upon to receive input and placement of materials.

2) The recordable disc of claim one in which the discs consist of CD's or DVD, or CD-Roms.

3) The recordable tape of claim one in which the tapes consist of audiotapes or videotapes.

4) The blank book of claim one in which the pages are of business letter size or larger.

5) The blank book of claim one in which the pages are less than business letter size.

6) The blank book of claim one is in which the binding is of the lace type allowing for removable pages.

7) The blank book of claim one in which the binding is of any other type allowing for removable pages.
